(19) United States
(12) Patent Application Publication
(10) Pub. No.: US 2008/0187173 A1
(43) Pub. Date: Aug. 7, 2008

(54) Method and apparatus for tracking video image

(75) Inventors: Jung-bae Kim, Hwaseong-si (KR); Young-su Moon, Seoul (KR); Gyu-tae Park, Anyang-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/889,428

(22) Filed: Aug. 13, 2007

(30) Foreign Application Priority Data
Feb. 2, 2007 (KR) 10-2007-0011122

(51) Int. Cl. G06K 9/00

(52) U.S. Cl. 382/103

(57) ABSTRACT

A video image tracking apparatus and a video image tracking method are provided. The method makes it possible to detect and track a target image having a variety of angles without a multi-view detector, easily adapt to addition of a new target image and removal of an existing target image, reduce calculation time and memory consumption for detecting and tracking the target image having a variety of angles, so that embedded software or chip can be realized, and tracking the target image at high speed.

### CROSS-REFERENCE TO RELATED PATENT APPLICATIONS

This application claims the benefit of Korean Patent Application No. 10-2007-0011122, filed on 2 Feb. 2007, in the Korean Intellectual Property Office, the disclosure of which is incorporated herein in its entirety by reference.

### BACKGROUND OF THE INVENTION

1. Field of the Invention

The present invention relates to a method and apparatus for tracking a video image, and more particularly, to a method and apparatus for tracking a video image which perform the 3As (auto focusing, auto white balance, and auto exposure) using a face image captured by a digital camera, a camcorder, and a cellular phone.

2. Description of the Related Art

As image processing technology has developed, a variety of technologies for detecting and tracking faces are being developed. Since portable image taking devices have limited size, power, and computing resources, but need to perform real-time processing, systems for detecting and tracking faces adapted to portable image taking devices are required.

In “Robust Real-time Object Detection (2001)” by Viola and Jones, a method of detecting a person's full face in real time using a discriminative boosting technique is disclosed. However, a full face detector is too limited to find out various angles of a face due to a difference between a full face and a facial profile.

In “Vector Boosting for Rotation Invariant Multi-view Face Detection (2005)” by Chang Huang, a multi-view detection system for detecting a multi-view face using a vector boosting technique is disclosed. However, calculation time and memory consumption increase in the multi-view detection system, which is limited to detect and track a moving target.

In “Kernel-Based Object Tracking (2003)” by Dorin Comaniciu, a mean shift-based tracking method is disclosed. However, since the method uses kernel calculation and increases the complexity of calculation of similarity and tracking location, the method is not used to detect a target in real time and at high speed, and fails to track a new target.

### SUMMARY OF THE INVENTION

The present invention provides a method and apparatus for tracking a video image, which makes it possible to detect and track a target image having a variety of angles without a multi-view detector, easily add a new target image and remove an existing target image, reduce calculation time and memory consumption for detecting and tracking the target image having a variety of angles, thereby being realized as embedded software or chip, and tracking the target image at high speed.

According to an aspect of the present invention, there is provided a video image tracking method comprising: tracking a target model and determining a target candidate of a tracked frame; detecting a target image from the tracked frame or a frame subsequent to the tracked frame; and renewing the target model using the target candidate or the target image and initializing tracking.

The renewing of the target model may comprise: if an overlapping region between the target candidate and the target image is greater than a predetermined reference value, removing the target candidate and renewing the target model using the target image.

The tracking of the target model may comprise: calculating a similarity or distance between the statistical distribution characteristic of the target model and a statistical distribution characteristic of a target candidate identified as a result of tracking a frame previous to the tracked frame, modifying the location of the target candidate based on the target model and the statistical distribution characteristic of the target candidate, calculating a similarity or distance between the statistical distribution characteristic of the target model and a statistical distribution characteristic of the target candidate according to the modified location of the target candidate, and performing tracking using the similarity or the distance.

According to another aspect of the present invention, there is provided a video image tracking apparatus comprising: a tracking unit tracking a target model and determining a target candidate of each frame; a detector detecting a target image at predetermined frame intervals; and a controller renewing the target model using the target candidate determined by the tracking unit and the target image detected by the detector, and initializing tracking.

The tracking unit may comprise: a tracking location determiner determining the target candidate in a frame to be tracked based on a statistical distribution characteristic of the target model; and a histogram extractor extracting a histogram reflecting a statistical distribution characteristic of the target candidate determined by the tracking location determiner.

The controller may comprise: a scheduler managing a tracking process performed by the tracking unit and a detecting process performed by the detector; and a combiner combining the target candidate and the target image and renewing the target model.

According to another aspect of the present invention, there is provided a computer readable recording medium having embodied thereon a computer program for executing the video image tracking method.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a video image tracking apparatus according to an embodiment of the present invention;

FIG. 2 is a diagram illustrating tracking video images obtained by the video image tracking apparatus as illustrated in FIG. 1, according to an embodiment of the present invention;

FIG. 3 is a diagram illustrating a combination video image obtained by the apparatus for tracking the video image as illustrated in FIG. 1, according to an embodiment of the present invention;

FIG. 4 is a flowchart of a video image tracking method according to an embodiment of the present invention; and

FIG. 5 is a detailed flowchart of Operation 500 as illustrated in FIG. 4, according to an embodiment of the present invention.

### DETAILED DESCRIPTION OF THE INVENTION

The present invention will now be described more fully with reference to the accompanying drawings, in which exemplary embodiments of the invention are shown.

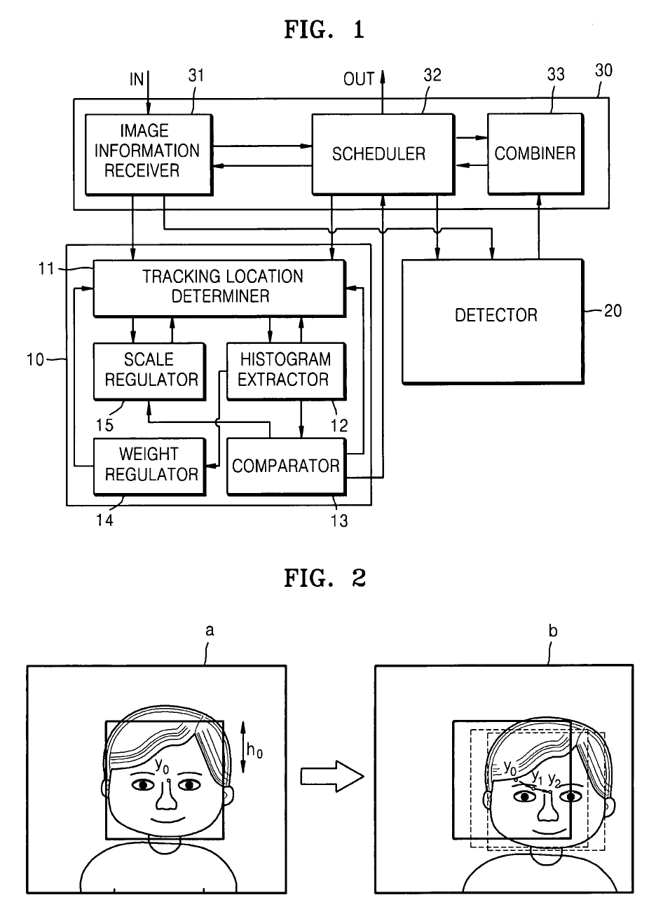

FIG. 1 is a block diagram of a video image tracking apparatus according to an embodiment of the present invention. Referring to FIG. 1, the video image tracking apparatus includes a tracking unit 10, a detector 20, and a controller 30.

The tracking unit 10 tracks a predetermined target model to determine a target candidate based on a current frame, i.e., an n^{th} frame. The tracking is repeated by a specific number of times until the tracking unit 10 determines a final target candidate according to the current frame.

In the present embodiment, the predetermined target model tracked by the tracking unit 10 is a sub-image or its histogram determined by tracking initialization at a frame previous to the current frame. The tracking initialization is carried out at regular intervals of frames starting from a frame from which an initial target image is detected. If an initial target image is detected, the detection result leads to the tracking initialization. However, if a subsequent target image is detected, a combination of tracking and detection results leads to the tracking initialization. For example, a target model may be a detected face image, i.e., an image having a region including a face. Further, the target candidate results from the repetitive tracking within the current frame, and is an image identified by a specific location and size.

The tracking unit 10 includes a tracking location determiner 11, a histogram extractor 12, a comparator 13, a weight regulator 14, and a scale regulator 15.

The tracking location determiner 11 determines the location of a sub window identifying the target candidate in frame-unit image information. The frame-unit image information is received from an image information receiver 31. In the present embodiment, since the sub window is identified by its center location y and half width h, the identified sub window leads to identification of the target model that is part of an entire frame image.

If a target or a video image taking device moves, the size and location of the sub window identifying the target candidate vary in each frame. The tracking location determiner 11 identifies the sub window in each frame using inputs received from the histogram extractor 12, the comparator 13, the weight regulator 14, the scale regulator 15, and a scheduler 32 whenever the tracking is carried out. For example, after a photography mode of the video image starts, the tracking location determiner 11 tracks an initial face model in a frame subsequent to a frame at which tracking is initialized based on the initial face model to determine a face candidate.

The initial face model is an initially detected face image or a color histogram of the initially detected face image as a first frame or a frame subsequent to the first frame. The detector 20 detects the initial face model. The scheduler 32 stores a result of the detection by the tracking initialization. The tracking location determiner 11 tracks a target of a current frame, i.e., the location of a face, based on a location and a histogram of the detected face model.

If the tracking is carried out at least once, the tracking location determiner 11 calculates the center location y and half width h for identifying the target candidate of the current frame using a result of the calculation of the comparator 13 or the weight regulator 14, and determines an image identified by the center location y and half width h as the target candidate of the current frame.

The histogram extractor 12 extracts a histogram reflecting statistical distribution characteristics of the target candidate identified by the tracking location determiner 11. The histogram extractor 12 extracts a histogram reflecting statistical distribution characteristics of an initialized target candidate stored by the scheduler 32. An example of the histogram in the present embodiment is the color histogram or an edge histogram. The histogram extractor 12 calculates the color histogram of the target model according to equation 1 below,

$${q}_{u} = {\sum }_{i = 1}^{n} δ [ b ( {x}_{i} ) - u ] \qquad 1 )$$

wherein xᵢ denotes (“the number of”?) a plurality of pixels forming the target model, b(xᵢ) denotes a bin value of each pixel, u denotes colors of the pixels, and qᵤ denotes a color histogram according to each of the colors u of the pixels. {qᵤ} denotes a set of pixels having the colors u among the plurality of pixels forming the target model. {qᵤ} reflects critical statistical distribution characteristics reflecting the features of the target model, and can be briefly calculated according to equation 2 below,

{qᵤ}_{u=1 . . . m}=histogram(r>>4,g>>4,b>>4) 2)

wherein, qᵤ denotes a histogram of the target model, r>>4, g>>4, and b>>4 denote left-shifting of r, g, and b, respectively, and m denotes 16×16×16. In more detail, qᵤ denotes the histogram obtained by dividing the r, g, and b by 2⁴.

Pixel colors are generally expressed as RGB values in the range 0˜255, which increases the complexity of calculation and processing time. However, to address this problem, the present invention lowers the degree of dispersion of the RGB values and expresses pixel colors using a new color variable u. For example, a three-dimensional RGB color obtained by dividing the r, g, and b values by 2⁴ and summing the divided r, g, and b values according to a predetermined weight is a color u having a primary value, and this procedure lowers the complexity of a calculation. Further, a probability density function (PDF) according to the target model can be used as qᵤ. When the PDF is used as qᵤ, qᵤ satisfies the equation

$${\sum }_{u = 1}^{m} {q}_{u} = 1.$$

As with the target model, a histogram of the target candidate can be calculated according to equation 3 below,

{pᵤ(y₀,h₀)}_{u=1 . . . m}=histogram(r>>4,g>>4,b>>4) 3)

wherein, {pᵤ(y₀, h₀)} denotes the histogram of the target candidate where a color value is u, a center coordinate is y₀, and a half width is h₀.

The comparator 13 calculates histogram similarities and compares the calculated similarities. In particular, the comparator 13 performs a comparison to determine if a predetermined target model is similar to a first target candidate or a second target candidate of the current frame. The first target candidate is obtained as a result of first tracking of the current frame (n^{th} frame). The second target candidate is obtained as a result of second tracking of the current frame (n^{th} frame).

The comparator 13 calculates a first similarity between color histograms of the first target candidate and the target model, calculates a second similarity between color histograms of the second target candidate and the target model, compares the calculated first and second similarities, and selects one of the first target candidate and the second target candidate that maximizes a tracking hit rate as the target candidate of the current frame.

For example, if the first similarity between color histograms of the first target candidate and the target model is smaller than the second similarity, the first target candidate is deleted and then the second target candidate is determined to be the target candidate of the current frame. If the current frame tracking is carried out, the comparator 13 compares the first and second target candidates and a third target candidate, and selects one of the first, second, and third target candidates that has the greatest similarity to the target model as the final target candidate of the current frame. If the first similarity between color histograms of the first target candidate and the target model is greater than the second similarity, the second target candidate is deleted and then the first target candidate is selected as the target candidate of the current frame. In this regard, since it is inefficient and unnecessary to track an additional target candidate, the current frame tracking is no longer carried out.

If similarity between the target candidate determined as a result of the final current frame tracking and the target model is smaller than a predetermined value, a current target model is deleted, and the current target model tracking is no longer carried out in a subsequent frame. For example, if one person among a plurality of people existing in a previous frame disappears, tracking of the face of the person that disappeared is no longer carried out.

The target candidate is determined based on similarities between histograms as described above. However, the target candidate can be determined using distances between histograms. Distances between histograms can be calculated using an L1 distance function according to equation 4 below,

$$d ( y ) = {\sum }_{u = 1}^{m} \vert \frac{{p}_{u} ( y )}{{N}_{p ( y )}} - \frac{{q}_{u}}{{N}_{q}} \vert = \frac{1}{{N}_{p ( y )} {N}_{q}} {\sum }_{u = 1}^{m} \vert {N}_{q} {p}_{u} ( y ) - {N}_{p ( y )} {q}_{u} \vert \qquad 4 )$$

wherein, d(y) denotes a distance between the target model and the target candidate, N_{q} denotes the number of pixels of the target model, Nₚ(y) denotes the number of pixels of the target candidate, pᵤ(y) denotes a color histogram of the target candidate, and qᵤ denotes a color histogram of the target model.

The weight calculator 14 calculates weights of all pixels belonging to the target candidate using the comparison result of the comparator 13. The tracking location determiner 11 calculates a new center location y₁ from the center location y₀ using the calculated weights according to equation 5 below,

$${y}_{1} = \frac{{\sum }_{i = 1}^{{n}_{h 0}} {w}_{i} {x}_{i}}{{\sum }_{i = 1}^{{n}_{h 0}} {w}_{i}} \qquad 5 )$$

wherein, Nₕ₀ denotes the total number of pixels of a tracking candidate model, and y₁ denotes a center coordinate of a tracking candidate modified according to a weight wᵢ. The center coordinate of the tracking candidate is modified according to the definition of the weight wᵢ. There is no particular restriction to a weight determining method. For example, when a face is tracked, a high weight is provided to a region of high frequency of a value u corresponding to complexion of the face on a histogram in order to move the center location y₀ to the center location y₁ of the high frequency region corresponding to the complexion. In more detail, the weight calculator 14 calculates the weight according to equation 6 below,

vᵢ=(Log(qᵤ)−Log(pᵤ(y)))>>1

sᵢ=min(max(vᵢ,−5),5)

wᵢ=1<<sᵢ 6)

wherein, wᵢ denotes a weight of each pixel, a Log( ) function denotes a function rounding off a log₂( ) value, i denotes a coordinate of a pixel, which is identified by a half width h₀, and 1<<sᵢ denotes 2^{si}. (Drafter: Is this correct?) Equation 6 is used to calculate the weight wᵢ using pᵤ and qᵤ(y) having the center location y and the color value u of the pixel coordinate i. In particular, since the weight wᵢ is an integral and can be calculated using a relatively easy operation in equation 6, equation 6 is suitable for calculating a weight in an embedded system.

The scale regulator 15 regulates a scale of the target candidate. When a distance between a video image tracking device and a person changes, it is necessary to regulate the scale in order to increase a hit rate in face tracking. The scale regulator 15 regulates the scale through regulation of a half width h. As an example of regulating the scale, if an original half width is denoted h₀, the scale regulator 15 regulates the scale of the target candidate using different half widths h₁, and h₂ like h₁=1.1h₀, h₂)=0.90h₀.

FIG. 2 is a diagram illustrating tracking video images obtained by the video image tracking apparatus as illustrated in FIG. 1, according to an embodiment of the present invention. Referring to FIG. 2, a video image “a” (of a previous frame) and a video image “b” (of a current frame) of two adjacent frames are obtained by an image obtaining apparatus such as a digital camera or a camcorder, in particular, an image obtaining apparatus having a tracking function.

In image “a”, y₀ denotes a center location of a target candidate determined as a result of final tracking of the previous frame, and h₀ denotes a half width of the target candidate. The target candidate of the video image “a” is an image in a region identified by a sub window. However, the video image “b” is obtained as a result of incomplete tracking of a target model. The tracking for determining the target candidate is repeated in the video image “b” of the current frame several times within a limited number of times.

Initial tracking of the video image “a” is carried out based on the same sub window condition, i.e. y₀ and h₀, of the target candidate determined in the video image “a” of the previous frame. A color histogram that is extracted from the target candidate determined through the sub window and a color histogram that is extracted from a predetermined target model can be used to calculate the weight wᵢ and the new center location y₁ according to equations 5 and 6.

The comparator 13 calculates a first similarity between color histograms of the first target candidate and the target model based on the sub window condition y₀, h₀, calculates a second similarity between color histograms of the second target candidate and the target model based on a new window condition y₁, h₀, compares the calculated first and second similarities, and selects one of the first target candidate and the second target candidate that has the greatest similarity to the target model as the target candidate of the video image b.

In FIG. 2, the target candidate is selected based on the new window condition y₁, h₀ instead of the sub window condition y₀, h₀. The weight calculator 14 calculates a new weight using values of the color histogram extracted from the selected target candidate and the color histogram extracted from the target model. The tracking location determiner 11 calculates a center location y₂ of a new sub window, h₀ using the new weight and the center location y₁ of the current sub window. The tracking location determiner 11 selects one of a third target candidate identified by the new sub window having coordinates y₂, h₀ and the second target candidate identified by the new window condition y₁, h₀ which has the greatest similarity to the predetermined target model. If the current frame tracking is complete, similarity between the finally selected target candidate and the target model is greater than a predetermined reference value, and the target model tracking continues. However, if the similarity therebetween is smaller than the predetermined reference value, the target model tracking no longer continues.

The detector 20 detects a target image from the video image. Taking into account the time required to detect the target image, the target image may be detected at intervals of a predetermined number of frames, e.g., 15 frames.

The controller 30 combines the target candidate identified by the tracking location determiner 10 and the target image detected by the detector 20 and renews the target model. Further, the controller 30 controls performance of the current frame tracking or detection of the target image, finishes the current frame tracking, and controls performance of next frame tracking.

The controller 30 comprises the image information receiver 31, the scheduler 32, and a combiner 33. The image information receiver 31 receives image information from an image obtaining means. The scheduler 32 schedules whether to perform the current frame tracking or detect the target image. The scheduler 32 also initializes tracking according to a combination image obtained by the combiner 33. The target model is renewed by the tracking initialization. The combiner 33 combines the target candidate determined by the tracking unit 10 and the target image detected by the detector 20.

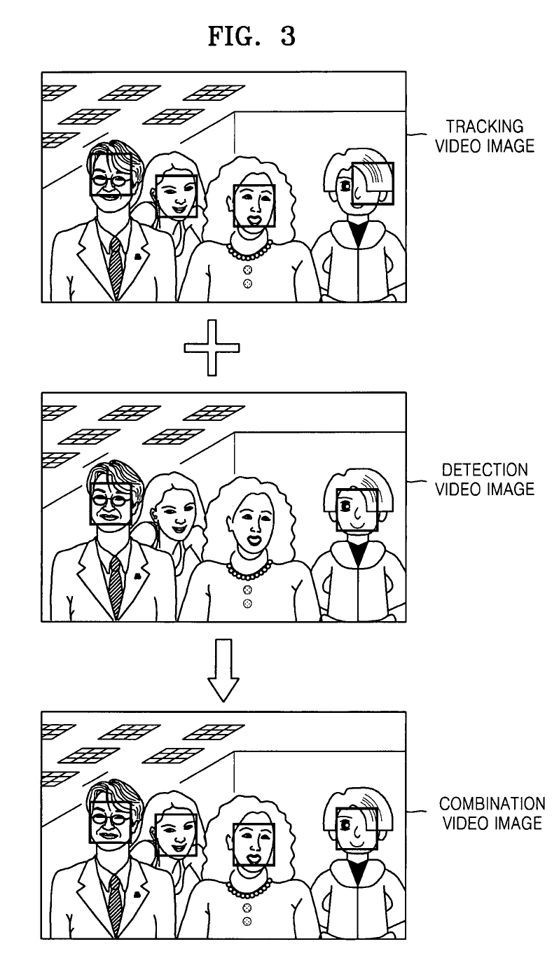

FIG. 3 is a diagram illustrating a combination video image obtained by the video image tracking apparatus as illustrated in FIG. 1, according to an embodiment of the present invention. Referring to FIG. 3, a tracking video image obtained by the tracking unit 10 includes four square sub windows that identify locations of target candidates. Video image tracking is performed per frame by a predetermined target model. Thus, when a new target that is not included in a previous frame appears on a current frame, it is impossible to track the new target in the current frame. Further, though a full face can be detected relatively accurately, it is difficult and takes much time to detect a facial profile. Thus, it is impossible to perform video image tracking per frame. In the present embodiment, tracking disadvantages are overcome by a combination of detection and tracking images.

In FIG. 3, a detection video image includes a target image detected using a full face detector for detecting a full face of the current frame. Although four face images are tracked in the tracking video image, the center two face images are not detected in the detection video image. A multi-view face detector capable of detecting the full face and the facial profile can detect the center two face images. However, since the multi-view detector needs a long detection time and consumes a lot of memory, it is difficult to operate the multi-view detector in real time. The tracking disadvantages can be overcome if targets in a video image are tracked and simultaneously detected using the full face detector and tracking and detection video images are combined.

Four face images in boxes in the tracking video image are target candidates of the current frame. Two face images in boxes of the detection video image are target images of the current frame. A right face image includes a target candidate consisting of a region partially overlapping the target image. If the partially overlapped region is greater than a predetermined reference value, the target candidate is removed. The combination video image includes the center two face images that are not detected in the tracking of targets in the video image and excludes both edge face images which are detected in the tracking video image. Tracking is initialized according to the combination video image and then the frame tracking is carried out according to the target model identified by the tracking initialization and the sub windows. In detail, the existing target model is applied to the center two face images and tracking for a subsequent frame is carried out based on the center location and the half width y, h. In the combination video image, the previously tracked images are removed from both edge face images and new target models are determined based on currently detected images. Center location and scale information of each of the target models are transferred to the tracking location determiner 11 through the scheduler 32. The tracking location determiner 11 performs tracking for the target models using sub windows of a previous frame. The tracking, detection, and combination process is repeated until a photography mode ends. If an overlapping region between a target candidate of a specific person and target models is smaller than the predetermined reference value, the target candidate and the target model are maintained and tracking for each target model is carried out in the subsequent frame. In detail, the tracking is carried out for two different target models extracted from one person's face image. However, repetitive tracking unites the two different target models, resulting in one target model for one person.

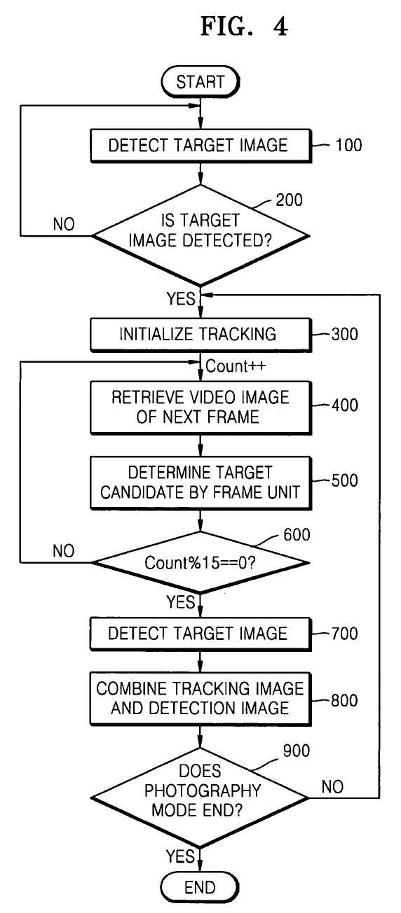

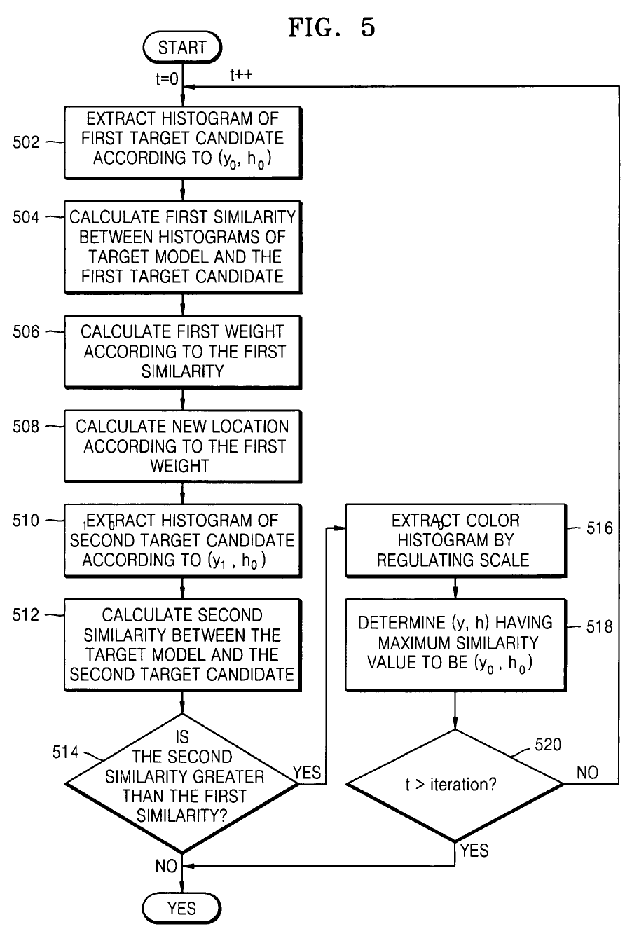

A video image tracking method of the present invention will now be described in detail with reference to FIGS. 4 and 5 and their embodiments.

FIG. 4 is a flowchart of a video image tracking method according to an embodiment of the present invention. Referring to FIG. 4, the video image tracking method of the present embodiment is performed in time series by a video image tracking apparatus.

If a photography mode starts, the detector 20 detects a target image in a video image of a first frame received from the image information receiver 31 (Operation 100). An example of the target image is a face image that is described in the present embodiment.

The scheduler 32 determines whether the target image is detected (Operation 200). If the scheduler 32 determines that the target image is not detected, the detector 20 detects the target image from a video image of a next frame.

If the scheduler 32 determines that the target image is detected, the scheduler 32 determines the detected target image as a target model, and initializes tracking (Operation 300). The tracking initialization means identification of a center coordinate y₀ and a half width h₀ of a sub window. If a new target appears, the tracking initialization includes (calculation of a histogram from the new target. The histogram extractor 12 extracts a color histogram or an edge histogram from the target model and stores the color histogram or the edge histogram.

The image information receiver 31 retrieves video image information of each frame (Operation 400). count⁺⁺ denotes an increase of a frame number by 1.

The tracking location determiner 11 determines a target candidate of each frame (Operation 500). The determination of the target candidate means determination of the location of the target candidate, i.e. information (y, h) of the sub window.

FIG. 5 is a detailed flowchart of Operation 500 as illustrated in FIG. 4, according to an embodiment of the present invention. Referring to FIG. 1, the histogram extractor 12 extracts a histogram of the target candidate (a first target candidate) according to the information (y₀, h₀) of the sub window from a video image of a second frame (Operation 502). In detail, the histogram extractor 12 extracts a histogram of the target candidate from the same location as the target model in a first frame. When tracking is performed without tracking a previous frame, the histogram extractor 12 extracts a histogram of the target candidate of a current frame from a specification location as a result of tracking the previous frame.

The comparator 13 calculates first similarity between histograms of the target model and the first target candidate (Operation 504). The target model and the first target candidate are within the same sub window. However, the target model and the first target candidate are different from each other in that the target model is an image identified in the first frame, whereas the first target candidate is an image identified in a second frame.

The weight regulator 14 calculates a first weight according to equation 6 using the histograms of the target model and the first target candidate (Operation 506).

The tracking location determiner 11 calculates a new center coordinate y₁ according to equation 5 using the first weight and the center coordinate y₀ of the sub window (Operation 508).

The histogram extractor 12 extracts a histogram of a second target candidate identified by coordinates (y₁, h₀) from a video image of the second frame (Operation 510).

The comparator 13 calculates second similarity between histograms of the target model and the second target candidate (Operation 512).

The comparator 13 compares the first and second similarities (Operation 514). If the second similarity is greater than the first similarity, the first target candidate is removed, and a subsequent tracking process follows location and scale of the second target candidate. Similarity and distance between the histograms have an inverse relationship. The comparator 13 calculates the distance between the histograms according to equation 4. If it is satisfied that d(y₀, h₀)>d(y₁, h₀), the tracking location determiner 11 performs tracking based on the coordinates (y₁, h₀). However, if it is satisfied that d(y₀, h₀)>d(y₁, h₀), since the distance between the first target candidate and the target model is shorter than that between the second target candidate and the target model, the second target candidate is removed, tracking for the current frame ends, and tracking for subsequent frames is performed based on the location of the first target candidate.

The scale regulator 14 regulates the scale of the target candidates, and the tracking location determiner 11 determines a new target candidate according to a newly regulated scale (Operation 516). The histogram extractor 12 extracts a color histogram from the new target candidate having a regulated scale.

The tracking location determiner 11 selects a pair of coordinates (y, h) having the maximum similarity value, and calculates a new pair of coordinates (y₀, h₀) using the selected coordinates (y, h) (Operation 518). For example, if h₁=1.1 h₀ (10% scale up), and h₂=0.9 h₀ (10% scale down), the tracking location determiner 11 calculates d(y₁, h₁) and d(y₁, h₂) and then calculates dₘᵢₙ of one of d(y₁, h₀), d(y₁, h₁), and d(y₁, h₂) which has the minimum center coordinate and half width. If dₘᵢₙ=d(y₁, h₀), then h₀=h₀. If dₘᵢₙ=d(y₁, h₁), then h₀=r₁h₁+(1−r₁)h₀. If dₘᵢₙ=d(y₁, h₂), then h₀=r₂h₂+(1−r₂)h₀. r1 and r2 are weights of center coordinates corresponding to the center coordinate h₀ and dₘᵢₙ according to previous tracking. For example, r₁ and r₂ can be set such that r₁=0.8, and r₂=0.2.

The scheduler 32 compares a tracking repetition number t of the current frame and a predetermined iteration value and determines whether the tracking unit 10 resumes tracking for the current frame, or the tracking unit 10 ends the tracking for the current frame and performs tracking for a next frame (Operation 520).

The scheduler 32 divides a number of the current frame by a definite number and determines whether a remainder is 0 (Operation 600). For example, when frames are detected at 15 frame intervals, the scheduler 32 divides the number of the current frame by 15 and determines whether the remainder is 0. If the remainder is 0, Operation 700 is performed. If the remainder is not 0, Operation 400 is performed. In other words, the detector 20 detects the target model every 15n frames (n is a positive number).

The detector 20 detects the target image from a tracked frame or a frame subsequent to the tracked frame (Operation 700). When a full face detector is used as the detector 20 in the present embodiment, the detector 20 detects a full face every 15 frames. Although the detector 20 does not detect a facial profile, the tracking unit 10 can capture it.

The combiner 33 combines a tracked image and a detected image (Operation 800). The combination is described with reference to FIG. 3 and thus its description is not repeated.

The scheduler 32 determines whether the photography mode ends (Operation 900). If the photography mode ends, the tracking process is complete. If the photography mode does not end, Operations 300 through 800 are repeated.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed network coupled computer systems so that the computer readable code is stored and executed in a distributed fashion. Also, functional programs, code and code segments for accomplishing the present invention can be easily construed by programmers skilled in the art to which the present invention pertains.

The present invention combines a tracking image and a detection image, initializes tracking according to a combination image, and performs further tracking based on the initialized tracking, thereby tracking a face having various angles without a multi-view target detector at high speed, and realizing 3As (auto focusing, auto white balance, and auto exposure) for a face image on a display screen of a next-generation digital still camera (DSC).

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A video image tracking method comprising:
tracking a target model and determining a target candidate of a tracked frame;
detecting a target image from the tracked frame or a frame subsequent to the tracked frame; and
renewing the target model using the target candidate or the target image and initializing tracking.

2. The method of claim 1, wherein the target model is tracked using a statistical distribution characteristic of the target candidate and a statistical distribution characteristic of the target model.

3. The method of claim 1, wherein the renewing of the target model comprises:
if an overlapping region between the target candidate and the target image is greater than a predetermined reference value, removing the target candidate and renewing the target model using the target image.

4. The method of claim 1, wherein the tracking of the target model comprises:
calculating a similarity or distance between the statistical distribution characteristic of the target model and a statistical distribution characteristic of a target candidate identified as a result of tracking a frame previous to the tracked frame, modifying the location of the target candidate based on the target model and the statistical distribution characteristic of the target candidate, calculating a similarity or distance between the statistical distribution characteristic of the target model and a statistical distribution characteristic of the target candidate according to the modified location of the target candidate, and performing tracking using the similarity or the distance.

5. The method of claim 1, wherein the target model is determined as a result of detecting a target image from the frame previous to the tracked frame.

6. The method of claim 2, wherein the statistical distribution characteristic is a color histogram or an edge histogram.

7. The method of claim 1, wherein the target candidate is determined according to a comparison result obtained by comparing similarity between the target model and the target candidate of the tracked frame and a predetermined reference value.

8. The method of claim 1, wherein each of an n^{th} frame (n is a positive number greater than 1) through an n+m^{th} frame (m is a positive number) is tracked, and the n+m^{th} frame or a frame subsequent to the n+m^{th} frame further is detected,
wherein the tracking of the target model comprises:
calculating a first similarity between the statistical distribution characteristic of the target model and a statistical distribution characteristic of a first target candidate of the n^{th} frame having the same location as the target model, and determining the location of a second target candidate of the n^{th} frame according to the first similarity;
calculating a second similarity between the statistical distribution characteristic of the target model and a statistical distribution characteristic of the second target candidate having the determined location; and
comparing first and second similarities, selectively determining the location of a third target candidate according to the comparison result, and calculating a third similarity between a statistical distribution characteristic of the third target candidate and the statistical distribution characteristic of the target model,
wherein one of the first, second, and third target candidates that has the maximum similarity value is selected as the target candidate of the tracked frame.

9. The method of claim 4, wherein the tracking of the target model is based on similarity or distance between the statistical distribution characteristic of the target model and statistical distribution characteristics obtained by regulating the scale of the target candidate.

10. The method of claim 1, wherein the target image is detected using full face features thereof.

11. The method of claim 6, wherein the color histogram of the target model is calculated according to the following equation,
$${q}_{u} = {\sum }_{i = 1}^{n} δ [ b ( {x}_{i} ) - u ]$$
wherein, xᵢ denotes the pixel location of the target model, b(xᵢ) denotes a bin value of a pixel, u denotes a color of the pixel, and qᵤ denotes a histogram according to the pixel color u.

12. The method of claim 4, wherein the distance is calculated according to the following equation,
$$d ( y ) = \frac{1}{{N}_{p ( y )} {N}_{q}} {\sum }_{u = 1}^{m} \vert {N}_{q} {p}_{u} ( y ) - {N}_{p ( y )} {q}_{u} \vert$$
wherein, d(y) denotes a distance between the target model and the target candidate, N_{q} denotes the number of pixels of the target model, Nₚ(y) denotes the number of pixels of the target candidate, Pᵤ(y) denotes a color histogram of the target candidate, and qᵤ denotes a color histogram of the target model.

13. The method of claim 8, wherein the first and second similarities are compared when the second similarity is greater than or the same as the first similarity.

14. A computer readable recording medium having embodied thereon a computer program for executing the method of claim 1.

15. A video image tracking apparatus comprising:
a tracking unit tracking a target model and determining a target candidate of each frame;
a detector detecting a target image at predetermined frame intervals; and
a controller renewing the target model using the target candidate determined by the tracking unit and the target image detected by the detector, and initializing tracking.

16. The apparatus of claim 13, wherein the tracking unit comprises:
a tracking location determiner determining the target candidate in a frame to be tracked based on a statistical distribution characteristic of the target model; and
a histogram extractor extracting a histogram reflecting a statistical distribution characteristic of the target candidate determined by the tracking location determiner.

17. The apparatus of claim 15, wherein the controller comprises:
a scheduler managing a tracking process performed by the tracking unit and a detecting process performed by the detector; and
a combiner combining the target candidate and the target image and renewing the target model.

18. The apparatus of claim 15, wherein, if an overlapping region between the target candidate of the tracked frame and the target image is greater than a predetermined reference value, the combiner removes the target candidate, and the controller initializes tracking by the target image.

19. The apparatus of claim 15, wherein, if the overlapping region between the target candidate of the tracked frame and the target image is smaller than the predetermined reference value, the controller determines the target image to be a tracking model.

20. The apparatus of claim 16, wherein the tracking location determiner determines the target candidate of the tracked frame based on statistical distribution characteristics obtained by regulating the scale of the target candidate.
